(19) United States
(12) Patent Application Publication
(10) Pub. No.: US 2024/0219887 A1
(43) Pub. Date: Jul. 4, 2024

(54) VIDEO ANALYSIS DEVICE, VIDEO ANALYSIS SYSTEM, AND STORAGE MEDIUM

(71) Applicant: FANUC CORPORATION, Yamanashi (JP)

(72) Inventors: Yuuki SUGITA, Yamanashi (JP); Nobuaki AIZAWA, Yamanashi (JP)

(21) Appl. No.: 18/557,047

(22) PCT Filed: May 24, 2021
(86) PCT No.: PCT/JP2021/019643

§ 371 Date: Oct. 25, 2023

(51) Int. Cl. G05B 19/408; G05B 19/4063; G06T 7/20; G06V 10/60; G06V 20/40

(52) U.S. Cl. CPC G05B 19/408; G05B 19/4063; G06T 7/20; G06V 10/60; G06V 20/46

(57) ABSTRACT

This video analysis device acquires a video of machining by a numerical control device, acquires a machining program for the numerical control device, and detects a characteristic frame from among the frames included in the video of the machining. The video analysis device detects, from among the blocks included in the machining program, a block that commands a machine tool to perform a characteristic operation. The video analysis device associates the characteristic frame with the block that commands the machine tool to perform the characteristic operation.

### TECHNICAL FIELD

The present invention relates to a video analysis device, a video analysis system, and a computer-readable storage medium.

### BACKGROUND ART

In the related art, there is a machine tool with a camera recording a video during machining. The machining video is sometimes required to be provided with NC program for checking the machining.

Patent Literature 1 discloses that “a machine data acquisition unit that acquires one or more types of machine data related to an operation of a machine chronologically based on first time information; a measurement data acquisition unit that acquires one or more types of measurement data obtained by measuring a state of the machine chronologically based on second time information; a first extraction unit that extracts a time point at which a preset feature indicating a predetermined event appears from any of the machine data; a second extraction unit that extracts a time point at which a preset feature indicating the predetermined event appears from any of the measurement data; and an output unit that outputs the machine data and the measurement data by synchronizing the time point extracted by the first extraction unit and the time point extracted by the second extraction unit are included”.

In Patent Literature 1, as a first example of a synchronization method, a torque instruction value included in machine data is synchronized with acoustic data included in measurement data. Specifically, the machine data and the measurement data are synchronized after start and end of machining is extracted using a torque instruction value, which is machine data and acoustic data, or acceleration data, which are measurement data.

Patent Literature 1 discloses that “when the machine data to be processed includes moving image data, a time point of a frame at which a preset feature indicating the predetermined event is shown may be extracted from the frame image of the moving image data”. In Patent Literature 1, a timing at which a tool comes into contact with a workpiece or a timing at which the tool is separated from the workpiece can be detected through image analysis.

### CITATION LIST

### Patent Literature

Patent Literature 1: JP 2019-219725 A

### SUMMARY OF INVENTION

### Technical Problem

An object of Patent Literature 1 is to synchronize a plurality of types of time-series data. As the plurality of types of time-series data, a torque instruction value, acoustic data, acceleration data, and moving image data are disclosed. In Patent Literature 1, these pieces of data are synchronized using time information. In this way, it is useful for machining analysis to associate moving image data with data such as torque instruction value and acceleration at a time point of machining.

In the technique of Patent Literature 1, however, data acquired at the time point of the machining and a machining program are not associated.

In the field of machining, there is a demand to associate a video recorded during machining with a machining program.

### Solution to Problem

According to an aspect of the present disclosure, a video analysis device includes: a video acquisition unit configured to acquire a machining video of a numerical controller; a machining program acquisition unit configured to acquire a machining program of the numerical controller; a video feature detection unit configured to detect a characteristic frame among frames included in the machining video; a machining program feature detection unit configured to detect a block instructing a machine tool to perform a characteristic operation among blocks included in the machining program; and a data association unit configured to associate the characteristic frame with the block instructing the machine tool to perform the characteristic operation.

According to another aspect of the present disclosure, a video analysis system includes: a video acquisition unit configured to acquire a machining video of a numerical controller; a machining program acquisition unit configured to acquire a machining program of the numerical controller; a video feature detection unit configured to detect a characteristic frame among frames included in the machining video; a machining program feature detection unit configured to detect a block instructing a machine tool to perform a characteristic operation among blocks included in the machining program; and a data association unit configured to associate the characteristic frame with the block instructing the machine tool to perform the characteristic operation.

According to still another aspect of the present disclosure, a storage medium stores computer-readable instructions with which one or a plurality of processors perform: acquiring a machining video of a numerical controller; acquiring a machining program of the numerical controller; detecting a characteristic frame among frames included in the machining video; detecting a block instructing a machine tool to perform a characteristic operation among blocks included in the machining program; and associating the characteristic frame with the block instructing the machine tool to perform the characteristic operation.

### Advantageous Effects of Invention

According to one aspect of the present invention, a machining video and a machining program can be associated with each other.

### BRIEF DESCRIPTION OF DRAWINGS

FIG. 1 is a conceptual diagram illustrating a relationship between a numerical controller and an external device.

FIG. 2 is a diagram illustrating an example of an input unit.

FIG. 3 is a block diagram illustrating the numerical controller according to a first disclosure.

FIG. 4 is a diagram illustrating a change in luminance.

FIG. 5 is a diagram illustrating an example of a change in luminance in a region of interest.

FIG. 6 is a diagram illustrating a change in motion.

FIG. 7 is a diagram illustrating movement of feature points in a region of interest.

FIG. 8 is a diagram illustrating a block instructing a machine tool to perform a characteristic operation.

FIG. 9 is a diagram illustrating a method of calculating a processing time.

FIG. 10 is a diagram illustrating relationships between frames with marks, the number of frames, and a time.

FIG. 11 is a diagram illustrating a relationship between a block instructing a machine tool to perform a characteristic operation and an execution time of the block.

FIG. 12 is a diagram illustrating an example in which the number of blocks instructing a machine tool to perform a characteristic operation is larger than the number of marks.

FIG. 13 is a flowchart illustrating an operation of the numerical controller.

FIG. 14 is a diagram illustrating an example in which a block of a machining program associated with a video of machining is displayed.

FIG. 15 is a diagram illustrating a hardware configuration of the numerical controller.

### DESCRIPTION OF EMBODIMENTS

Hereinafter, the present disclosure will be described.

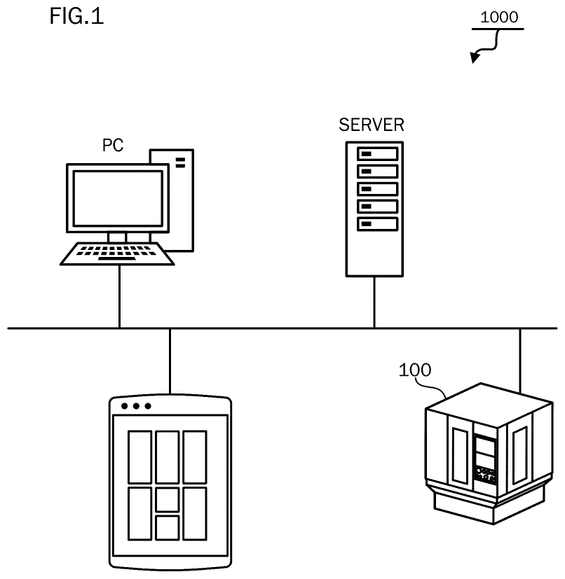

As illustrated in FIG. 1, in the present disclosure, a video analysis device is mounted on a numerical controller 100. The video analysis device may be mounted on an information processing device such as a personal computer (PC), a server, or a mobile terminal. Components of a video analysis device may be mounted on a video analysis system 1000 that performs distributed processing on a plurality of information processing devices on a network.

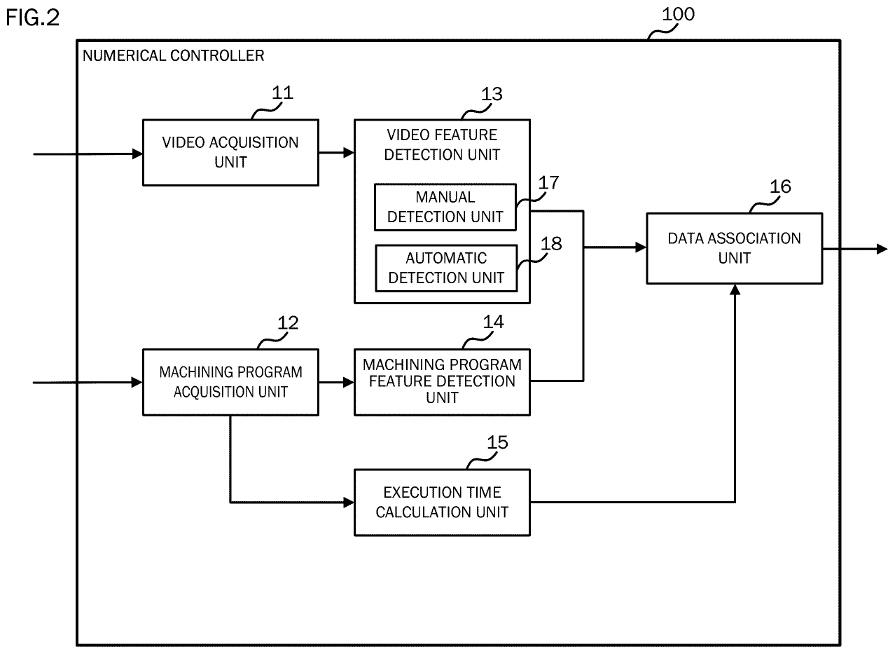

FIG. 2 is a block diagram illustrating the numerical controller 100. The numerical controller 100 includes a video acquisition unit 11, a machining program acquisition unit 12, a video feature detection unit 13, a machining program feature detection unit 14, an execution time calculation unit 15, and a data association unit 16.

The video acquisition unit 11 acquires a machining video of the machine tool. The machining video may be acquired directly from camera, may be acquired from a storage device of the numerical controller 100 or an external storage device. The machining program acquisition unit 12 acquires a machining program. The machining program is acquired from the storage device of the numerical controller 100 or an external storage device.

The video feature detection unit 13 detects characteristic frames from frames included in the machining video and marks the detected frame. The marking means, for example, embedding of information indicating detection to the detected frame or storing frame numbers, time information, the frames themselves, somewhere outside of the frames or the like.

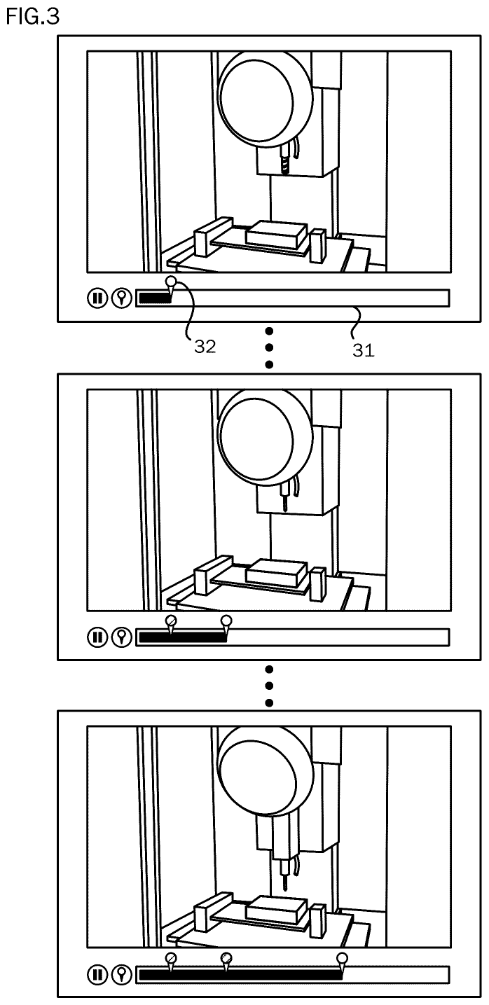

The video feature detection unit 13 includes a manual detection unit 17 and an automatic detection unit 18. The manual detection unit 17 presents the video to the operator and marks the video designated by the operator. For example, as illustrated in FIG. 3, the machining video is displayed, and a seek bar 31 is displayed below the video. When the operator looks at the video and gives an instruction to mark the frame to a characteristic video such as a frame in which a tool is being replaced or a frame in which an interior light is turned on or off appears. In FIG. 3, an anchor 32 displayed on the seek bar is indicating a marked portion of the video.

The automatic detection unit 18 performs the marking on a characteristic video using an image processing scheme. In the present disclosure, a change in luminance and a change in motion have been exemplified as a detection scheme, but the present invention is not limited thereto.

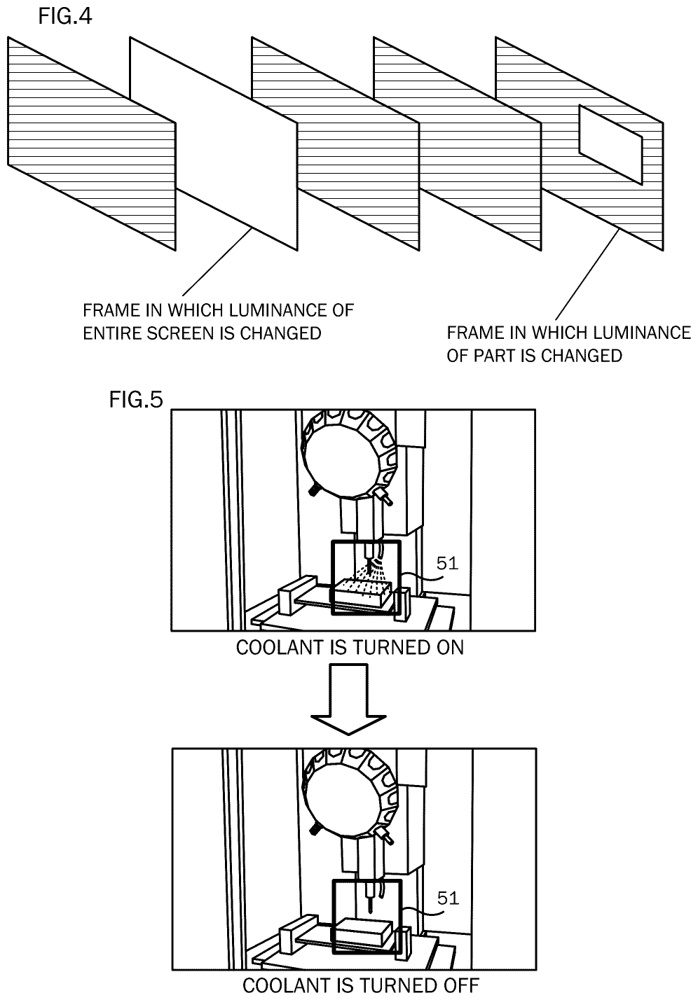

FIG. 4 illustrates an example of the change in luminance. Examples of the change in luminance include a case where the luminance of the entire video changes, a case where a ratio of specific luminance values changes, and a case where the luminance of a region of interest changes.

Examples in which the luminance of the entire video changes include ON/OFF of an interior light of a machine tool. The interior light of the machine tool is normally at OFF. When the operator works, the interior light is turned on. When the interior light is turned on, the entire interior becomes bright and the luminance increases. Conversely, when the interior light is turned off, the entire interior becomes dark and the luminance decreases. The automatic detection unit marks a frame in which the luminance of the entire video considerably changes as a characteristic frame.

FIG. 5 illustrates an example in which a change in luminance of a region of interest is detected.

In FIG. 5, the region where a coolant is discharged is set as a region of interest 51. When a workpiece is machined, that is, when the coolant is turned on, a proportion of the luminance of the coolant in the region of interest 51 is large. However, when the coolant is turned off, the proportion of the luminance of the coolant in the video becomes small. The luminance considerably changes by turning the coolant on and off. The automatic detection unit 18 compares a total sum of change amounts of luminance of all the pixels in the region of interest with a threshold, and marks, as a characteristic frame, a frame when the total sum of the change amounts of luminance of all the pixels in the region of interest exceeds the threshold.

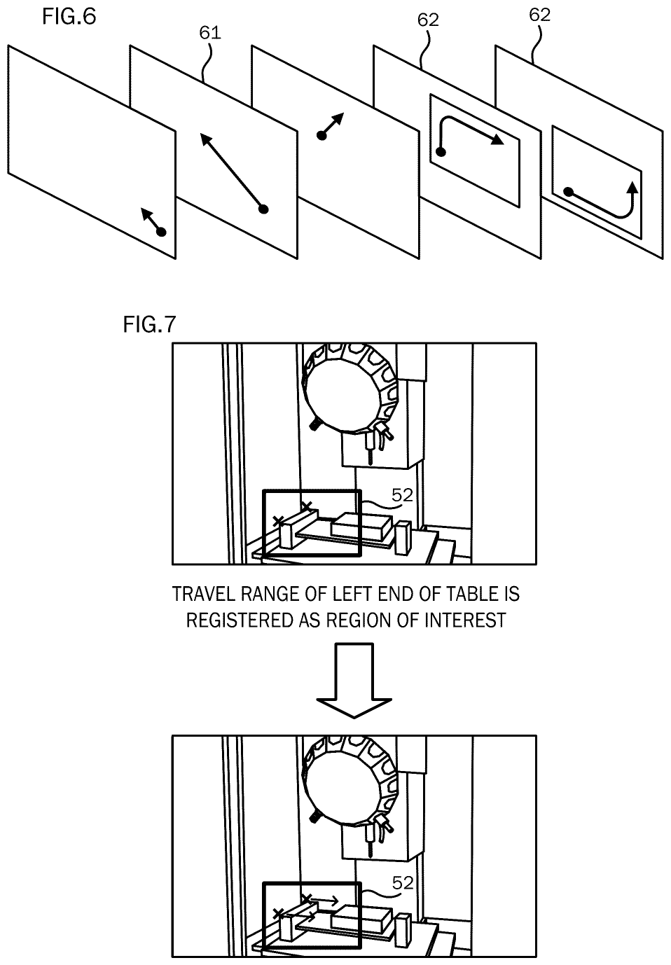

Next, a change in motion will be described. FIG. 6 illustrates an example of a change in motion. In the change in motion, a feature point is detected using an image processing technique, and a displacement vector of the feature point is detected. The automatic detection unit detects a frame 61 in which a movement amount of the feature point is large and a frame 62 in which the movement direction of the feature point considerably changes. The movement of the feature point may be extracted from the entire video or may be extracted from a region of interest 52 of the video.

Examples of the feature point detection method include, but are not limited to, scale-invariant feature transform (SIFT) and speeded-up robust features (SURF). SIFT and SURF detect a corner portion of an object as a feature point.

An example will be described, with reference to FIG. 7, in which movement of the feature point in the region of interest 52 is detected. A travel range of a workpiece, a jig, a table, or the like is set as a region of interest. In FIG. 7, the region of interest 52 is defined as a range in which a part of a table (an upper left corner) can be moved on which a workpiece is placed. In FIG. 7, two feature points are detected in the region of interest 52. The automatic detection unit 18 calculates movement amounts and movement directions of the two feature points. Then, when the movement amount of each feature point becomes larger than a threshold, marking is performed in a frame indicating a feature indicating a speed instruction changes. When the movement direction of each feature point is larger than the threshold, marking is performed in a frame indicating a feature of a change in a movement direction of an axis.

The machining program feature detection unit 14 detects a block (row) of the machining program instructing a machine tool to perform a characteristic operation. The block instructing the machine tool to perform the characteristic operation is, for example, a block in which a specific M code or a code having a large amount of change in the movement of the axis is described. The specific M code gives an instruction for discharge/stop of the coolant, storing of the tool, replacement of the tool, replacement of the workpiece, and the like. The machining program feature detection unit 14 extracts the block in which such the M code instructing a characteristic operation is described from the machining program.

The movement of the axis changes a lot when [1] a code instructs the movement direction of the axis to be reversed, [2] a code instructs the movement direction of the axis to be changed more than the threshold, and [3] a code instructs the speed of the axis to change considerably, such as rapid-traverse from cutting feed. The amount of change in the movement of the axis can be detected from the machining program. In the machining program of FIG. 8, the movement of the axis is reversed in the block in which “X-10.” is described, and the condition of [1] is satisfied. In the block in which “Y10.” is described, the movement direction of the axis is changed from the X axis direction to the Y axis direction, and the condition of [2] is satisfied. In the block in which “G00 Y20.” is described, a movement amount increases from linear feed “G01” to rapid-traverse “G00”, the movement amount increases, and the condition of [3] is satisfied. The machining program feature detection unit 14 detects a block instructing the machine tool to perform the characteristic operation in this way.

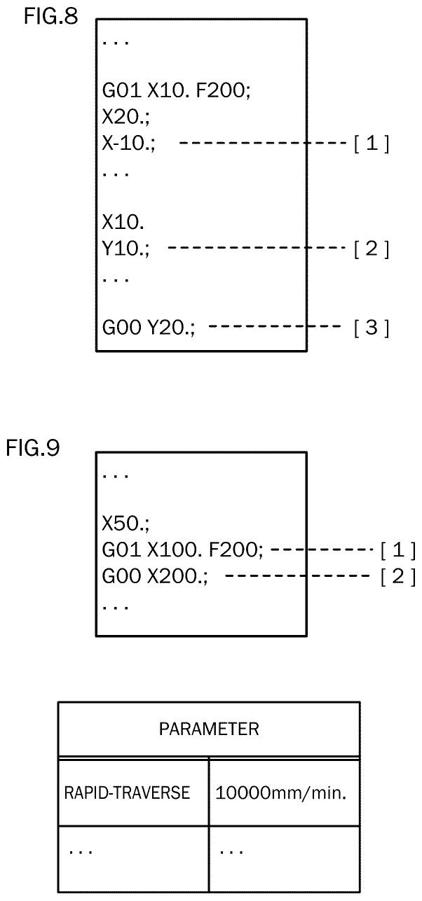

The execution time calculation unit 15 calculates an execution time of each block of the machining program. Examples of the method of calculating the execution time include a mathematical calculation method, a calculation method by simulation, and a calculation method by actual measurement. Mathematical calculation method uses an instruction coordinate value, a feed speed, and parameter information of the numerical controller 100 written in the machining program. The method of calculating the execution time will be described with reference to the machining program of FIG. 9. As an example, an execution time of [1] the block “G01 X100. F200;” in the second row and [2] the block “G00 X200.;” in the third row is calculated. In order to execute this machining program, it is assumed that “rapid-traverse speed: 10000 mm/min” is set. [1] In the block in the second row, since the movement is performed from X50. to X100. by linear feed at the speed of 200, the execution time can be calculated as (100−50)/200*60=15 seconds. [2] In the block in the third row, since the block moves by rapid traverse to X200., the execution time can be calculated as (200−100)/10000*60=0.6 seconds.

In the calculation by actual measurement, what number of block (row number) being executed is inquired at a constant cycle, and the execution time of one block is recorded at a timing at which the block number changes. In the calculation by simulation, simulation software calculates the execution time for each block. The method of calculating the execution time is a known technique which has already been disclosed in JP 2020-38671 A or the like.

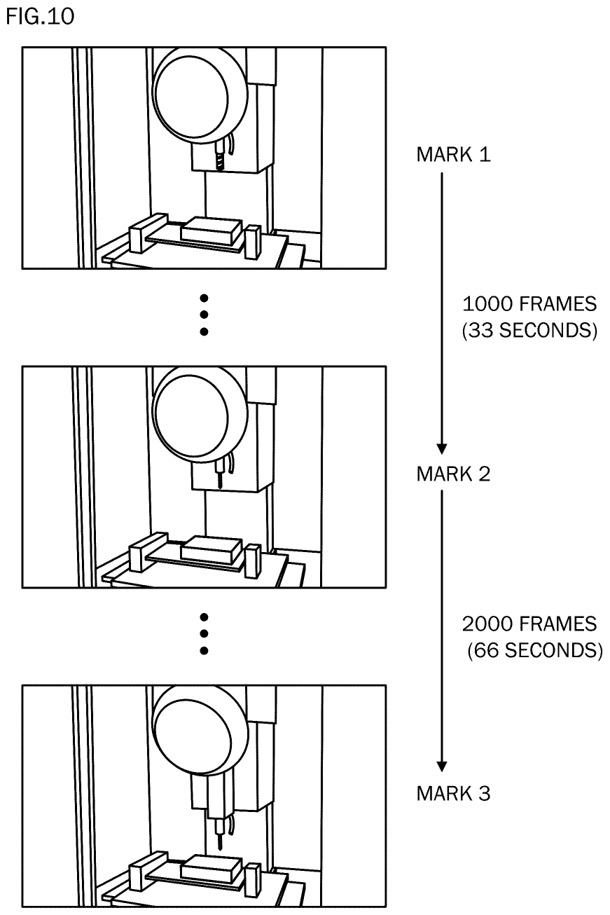

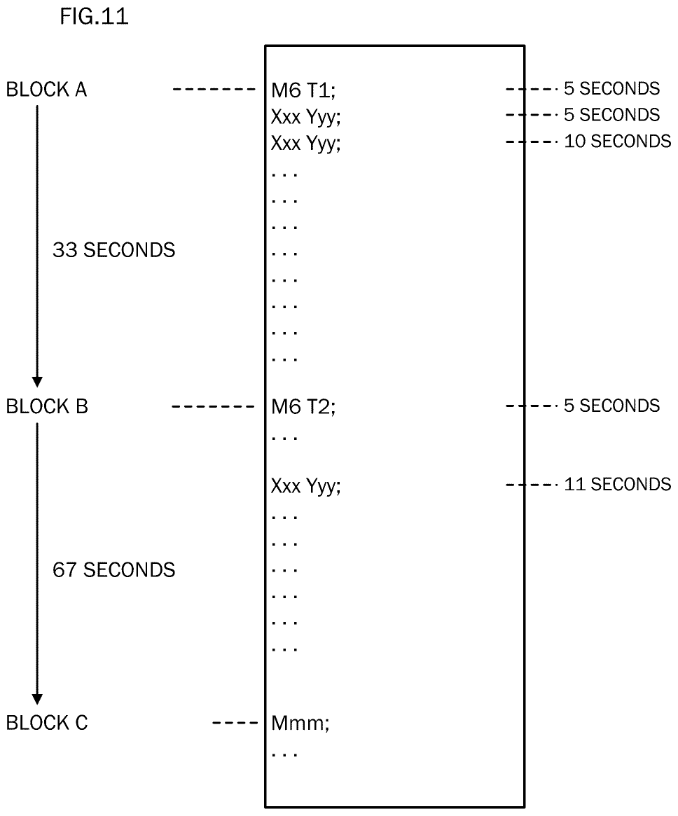

The data association unit 16 associates the frame detected by the video feature detection unit 13 with the block detected by the machining program feature detection unit 14. In the video of FIG. 10, there are three marks 1, 2, and 3. There are 1000 frames between the marks 1 and 2. On the assumption that a frame rate is 30 frames per second, 33 seconds can be calculated between the marks 1 and 2. The frame rate varies depending on an image compression method. There are 2000 frames between the marks 2 and 3. When the frame rate is 30 frames per second, a time of 66 seconds can be calculated between the marks 2 and 3.

FIG. 11 illustrates a relationship between an execution time and a block of a machining program instructing a machine tool to perform a characteristic operation. “M6” is a block instructing the tool to perform a characteristic operation of replacing the tool. In FIG. 11, blocks A, B, and C are extracted as blocks instructing a machine tool to perform the characteristic operation. “M6: Tool Replacement” is described in the block A, “M6: Tool Replacement” is described in the block B, and “M9: Coolant OFF” is described in the block C.

The data association unit 16 associates a characteristic frame with a block instructing a machine tool to perform a characteristic operation. In the examples of FIGS. 10 and 11, the mark 1 and the block A, the mark 2 and the block B, and the mark 3 and the block C are associated with each other.

The data association unit 16 associates the remaining frames and blocks with reference to the already associated frames and blocks. The execution time of the block is used for the association. A corresponding frame can be calculated from the execution time of the block and the frame rate. In the example of FIG. 10, the execution time of the block in the first row is 5 seconds, the execution time of the block in the second row is 5 seconds, and the execution time of the block in the third row is 10 seconds. A product of the execution time and the frame rate is the number of frames for each block. In this way, the frame and the block are associated with each other.

Some error is allowed in the association of the frame and the block. For example, a time between the mark 1 and the mark 3 in FIG. 10 is 66 seconds, and a time between the block B and the block C in FIG. 11 is 67 seconds. There is a 1 second gap in the time interval between the two features, but this gap is allowed. An object of the present disclosure is to perform rough association and does not require strict time matching.

Next, a case will be described where the number of characteristic frames and the number of blocks instructing the machine tool to perform a characteristic operation do not match. In the case of manual marking, the frame number manually marked changes due to oversight by the operator or a difference in sensation for each operator. In the case of automatic marking, unnecessary marking may happen. Unnecessary or unmarked frames cannot be associated with blocks.

The data association unit 16 associates frames with blocks using the execution time, and excludes frames having no association partner and blocks having no association partner.

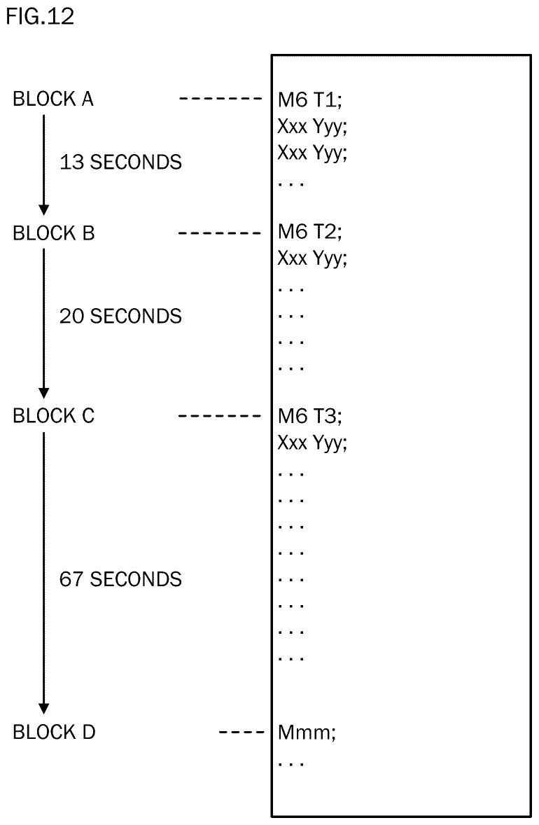

FIGS. 11 and 12 illustrate examples in which the number of blocks is greater than the number of marks. The video in FIG. 10 includes three of the marks 1, 2, and 3. In FIG. 12, however, four blocks of blocks A, B, C, and D are extracted. The data association unit 16 determines which marks and which blocks match based on a time of “13 seconds” between the blocks A and B, a time of “20 seconds” between the blocks B and C, and a time of “67 seconds” between the blocks C and D. In this example, there is no mark corresponding to the block B. Therefore, the block B is not used for association, and the blocks A, C, and D in which there are association partners are used.

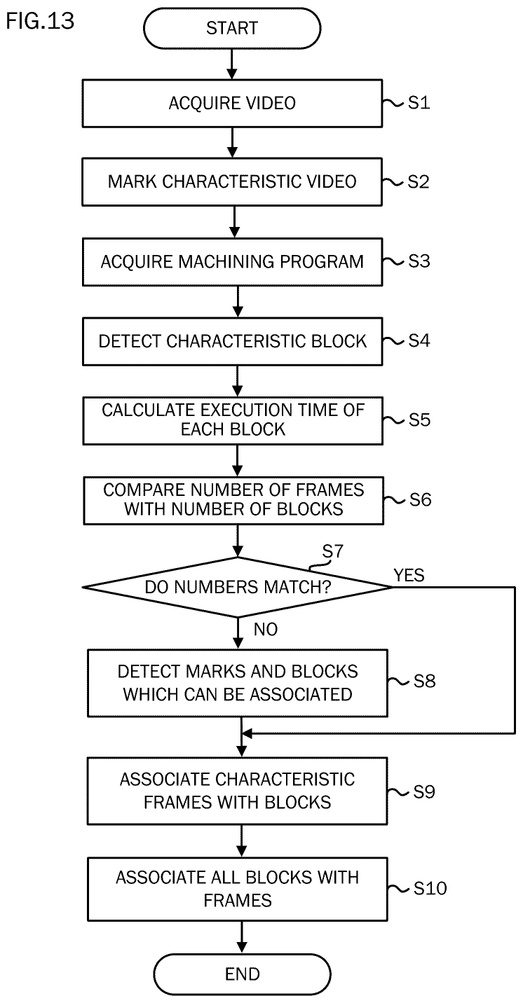

An operation of the numerical controller 100 will be described with reference to the flowchart of FIG. 13. The numerical controller 100 acquires a video (step S1). The numerical controller 100 marks the characteristic video (step S2). The marking method may be manual or automatic.

The numerical controller 100 acquires the machining program (step S3). The numerical controller 100 detects the block instructing the machine tool to perform the characteristic operation in the machining program (step S4).

The numerical controller 100 calculates the execution time of each block of the machining program (step S5). Examples of the method of calculating the execution time include a mathematical calculation method, a calculation method by simulation, and a calculation method by actual measurement.

The numerical controller 100 compares the number of marked frames with the number of detected blocks (step S6). When the number of marked frames match the number of detected blocks (YES in step S7), the process proceeds to step S9. When the number of marked frames is different from the number of detected blocks (NO in step S7), the numerical controller 100 compares a time of the marked frames with a time of the detected blocks and determines the temporally related frames and blocks as the marks and blocks that can be associated with each other (step S8).

The numerical controller 100 associates the frames detected in step S2 with the blocks detected in step S4 (step S9).

Using the execution time of the block and the frame rate, the numerical controller associates the blocks with the frames of the video other than the blocks associated in step S9 (step S10). As a result, all the blocks of the machining program are associated with the frames of the video.

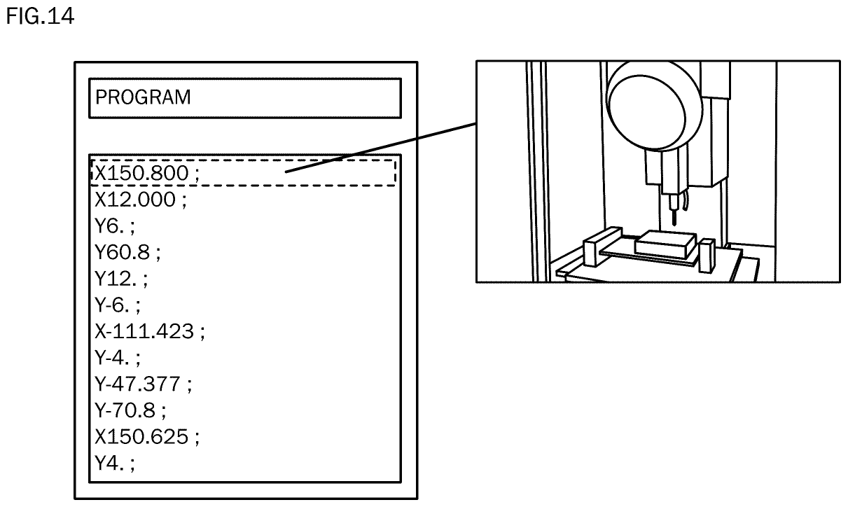

As described above, the numerical controller 100 according to the present disclosure can associate the machining video recorded during machining with the blocks of the machining program. By associating the machining video with the machining program, as illustrated in FIG. 14, the blocks and the machining can be visually analyzed with the video.

The numerical controller according to the present disclosure associates a video with a machining program with a simple method. In fields of image processing, there is also a technique of performing image analysis using machine learning. However, when machine learning is used, it is necessary to perform learning under certain conditions.

The structure of the numerical controller according to the present disclosure is simple since the numerical controller uses a general image processing method such as a change in luminance and a displacement vector. When the characteristic video is manually marked, the task of detecting characteristic image passes to a person. Therefore, the association of the video and the program can be achieved with a simpler configuration.

In either the automatic detection or the manual detection, erroneous determination or determination omission of frames occurs. However, frames that are not having no association partner are not used for association, and thus high detection accuracy is not required.

In order to increase detection accuracy, a machine learning detection unit specialized for an intended event may be generated for each event. For example, a detection unit of machine learning specialized for an event, such as a detection unit detecting tool replacement, a detection unit detecting workpiece replacement, and a detection unit detecting ON/OFF of a coolant, may be trained in advance. When any one of the detection units has a score equal to or larger than a threshold, it can be detected as frames having video features.

### [Hardware Configuration]

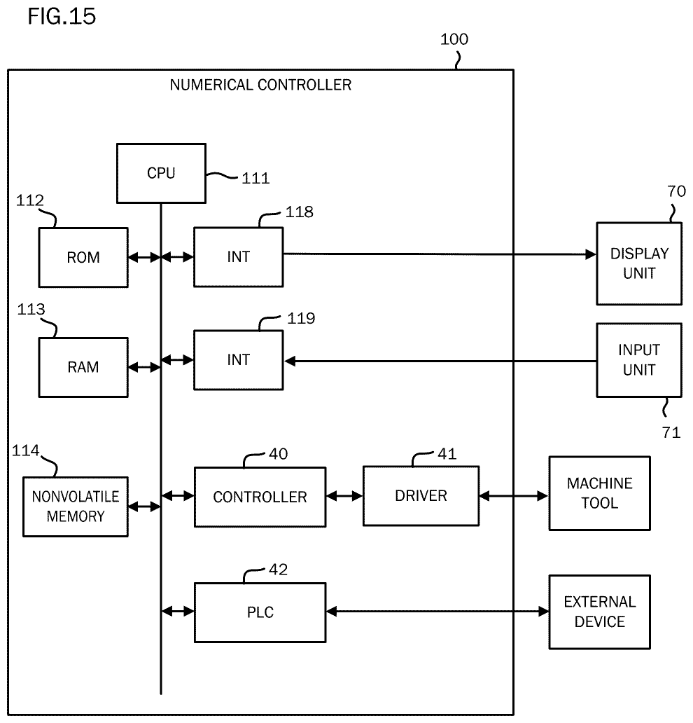

A hardware configuration of the numerical controller 100 will be described with reference to FIG. 15. The CPU 111 included in the numerical controller 100 is a processor that controls the numerical controller 100 as a whole. The CPU 111 reads a system program stored on the ROM 112 via a bus, and controls the entire numerical controller 100 in accordance with the system program. The RAM 113 temporarily stores temporary calculation data, display data, various types of data input by the user via the input unit 71, and the like.

The display unit 70 is a monitor or the like attached to the numerical controller 100. The display unit 70 displays an operation screen, a setting screen, and the like of the numerical controller 100.

The input unit 71 is a keyboard, a touch panel, or the like integrated with the display unit 70 or separate from the display unit 70. A user operates the input unit 71 to perform an input into a screen displayed on the display unit 70 or the like. The display unit 70 and the input unit 71 may be mobile terminals.

A nonvolatile memory 114 is, for example, a memory that is backed up by a battery (not illustrated) or the like and keeps a storage state even when a power supply of the numerical controller 100 is turned off. The nonvolatile memory 114 stores a program read from an external device via an interface (not illustrated), a program input via the input unit 71, and various types of data (for example, setting parameters acquired from a machine tool, and the like) acquired from each unit of the numerical controller 100, the machine tool, or the like. The programs and various types of data stored in the nonvolatile memory 114 may be loaded to the RAM 113 at the time of execution/use. Various system programs are written in the ROM 112 in advance.

The controller 40 that controls a tool of the machine tool converts an axis movement command from the CPU 111 into a pulsed signal and outputs the pulsed signal to the driver 41. The driver 41 converts the pulsed signal into a current to drive a servo motor of the machine tool. The servomotor moves a tool or a table under the control of the numerical controller 100.

The PLC 42 controls an external device. Examples of the external device include a tool changer and a coolant.

### REFERENCE SIGNS LIST

100 Numerical controller
11 Video acquisition unit
12 Machining program acquisition unit
13 Video feature detection unit
14 Machining program feature detection unit
15 Execution time calculation unit
16 Data association unit
17 Manual detection unit
18 Automatic detection unit
50, 51, 52 Region of interest
111 CPU
112 ROM
113 RAM
114 Nonvolatile memory

1. A video analysis device comprising:
a video acquisition unit configured to acquire a machining video of a numerical controller;
a machining program acquisition unit configured to acquire a machining program of the numerical controller;
a video feature detection unit configured to detect a characteristic frame among frames included in the machining video;
a machining program feature detection unit configured to detect a block instructing a machine tool to perform a characteristic operation among blocks included in the machining program; and
a data association unit configured to associate the characteristic frame with the block instructing the machine tool to perform the characteristic operation.

2. The video analysis device according to claim 1, further comprising:
an execution time calculation unit configured to calculate an execution time of each block included in the machining program,
wherein the data association unit sets the already associated characteristic frame and the block instructing the machine tool to perform the characteristic operation as a reference and associates the frames included in the machining video with the blocks included in the machining program based on the execution time of each of the blocks and a frame rate of the machining video.

3. The video analysis device according to claim 2, wherein the data association unit associates the characteristic frame with the block instructing the machine tool to perform the characteristic operation based on the execution time of the block, and excludes a frame having no association partner and a block having no association partner.

4. The video analysis device according to claim 1, wherein the video feature detection unit includes a manual detection unit that receives an input from an operator and detects the characteristic frame based on an instruction of the operator.

5. The video analysis device according to claim 1, wherein the video feature detection unit includes an automatic detection unit that detects the characteristic frame based on at least one of a change in luminance or a change in motion.

6. The video analysis device according to claim 1, wherein the machining program feature detection unit detects the block instructing the machine tool to perform the characteristic operation based on a type of code included in the block and a coordinate value of the code.

7. A video analysis system comprising:
a video acquisition unit configured to acquire a machining video of a numerical controller;
a machining program acquisition unit configured to acquire a machining program of the numerical controller;
a video feature detection unit configured to detect a characteristic frame among frames included in the machining video;
a machining program feature detection unit configured to detect a block instructing a machine tool to perform a characteristic operation among blocks included in the machining program; and
a data association unit configured to associate the characteristic frame with the block instructing the machine tool to perform the characteristic operation.

8. A storage medium storing computer-readable instructions with which one or a plurality of processors perform:
acquiring a machining video of a numerical controller;
acquiring a machining program of the numerical controller;
detecting a characteristic frame among frames included in the machining video;
detecting a block instructing a machine tool to perform a characteristic operation among blocks included in the machining program; and
associating the characteristic frame with the block instructing the machine tool to perform the characteristic operation.
